(19) United States
(12) Patent Application Publication
(10) Pub. No.: US 2008/0259285 A1
(43) Pub. Date: Oct. 23, 2008

(54) ILLUMINATION OPTICAL SYSTEM AND IMAGE PROJECTION DEVICE

(75) Inventor: Yasumasa Sawai, Yamatotakada-shi (JP)

Correspondence Address: SIDLEY AUSTIN LLP, 717 NORTH HARWOOD, SUITE 3400, DALLAS, TX, 75201, US

(73) Assignee: Konica Minolta Opto, Inc., Tokyo (JP)

(21) Appl. No.: 12/103,208

(22) Filed: Apr. 15, 2008

(30) Foreign Application Priority Data
Apr. 20, 2007 (JP) 2007-112274

(51) Int. Cl. G03B 21/14; G03B 21/26

(52) U.S. Cl. 353/31; 353/94

(57) ABSTRACT

An illumination optical system has: a light source, a first optical member, a second optical member, and a rod integrator, and illuminates an image display surface of a display element. The light source emits illumination light having a flat beam cross section. The first optical member reduces flatness of the beam cross section. The second optical member condenses or diverges the illumination light. The rod integrator uniformizes spatial energy distribution of the illumination light subjected to optical action of the first and second optical members.

This application is based on Japanese Patent Application No. 2007-112274 filed on Apr. 20, 2007, the contents of which are hereby incorporated by reference.

### BACKGROUND OF THE INVENTION

1. Field of the Invention

The present invention relates to an illumination optical system and an image projection device, and more specifically to an image projection device having, for example, a digital micromirror device or a liquid crystal display (LCD) as a display element and an illumination optical system for illuminating an image display surface of the display element in the image projection device.

2. Description of Related Art

A surface emitting semiconductor laser array has received attention as a light source for a projector. This semiconductor laser array often has very flat light source arrangement, for example, 1 or 2 rows by 10 numeric sequences. Thus, when illumination is achieved with such a laser array light source, NA (numerical aperture) of illumination light varies depending on directions. On the other hand, an optical system of, for example, a projection lens used in a projector has isotropic NA.

With illumination light with flat NA as described above, adjusting the optical system to smaller NA results in failure to transmit a larger NA component of the illumination light. On the other hand, adjusting the optical system to larger NA leads to upsizing of the optical system, which results in poor total efficiency. Moreover, adjusting the optical system to the larger NA of the illumination light with appropriate NA (for example, NA=0.2) greatly reduces the smaller NA (for example, NA=0.025) of the illumination light, resulting in failure to provide resolution for the smaller NA of a projected image. As described above, the use of a laser array light source presents a problem of flat NA distribution. Patents Documents 1 and 2 listed below provide examples of an illumination optical system using a light source with flat NA distribution.

Patent Document 1: U.S. Pat. No. 6,856,727

Patent Document 2: U.S. Pat. No. 5,704,700

The light source described in Patent Document 1 is not a laser array light source but has a taper rod used in the illumination optical system for the purpose of correcting flat NA distribution to isotropic NA distribution. However, the taper rod as an integrator is difficult to manufacture, and its use becomes a factor leading to cost increase and upsizing of the entire illumination optical system. Thus, there has been a demand for an illumination optical system that provides high illumination efficiency even with a typical rod integrator formed in the shape of a quadrangular prism (rectangular parallelepiped or the like).

In the illumination optical system described in Patent Document 2, a laser array is used as the light source, and a pair of lens arrays are used which permit homogeneous illumination having rectangular distribution with a beam, from the laser array light source, having Gaussian distribution. However, no consideration is given to NA isotropy, and thus a problem attributable to flat NA distribution remains unresolved.

### SUMMARY OF THE INVENTION

In view of such a circumstance, the present invention has been made, and it is an object of the invention to provide an illumination optical system which includes a light source emitting a beam having a flat cross section and also which provides an illumination beam having isotropic NA distribution while having compact configuration, and also to an image projection device using such an illumination optical system.

According to one aspect of the invention, an illumination optical system for illuminating an image display surface of a display element includes: a light source emitting illumination light having a flat beam cross section; a first optical member reducing flatness of the beam cross section; a second optical member condensing or diverging the illumination light from the first optical member; and a rod integrator uniformizing spatial energy distribution of the illumination light subjected to optical action of the first and second optical members.

According to another aspect of the invention, an image projection device including: an illumination optical system including: a light source emitting illumination light having a flat beam cross section, a first optical member reducing flatness of the beam cross section, a second optical member condensing or diverging the illumination light from the first optical member, and a rod integrator uniformizing spatial energy distribution of the illumination light subjected to optical action of the first and second optical members; a display element forming an image by modulating the illumination light from the rod integrator; and a projection optical system projecting on an enlarged scale the image formed by the display element.

### BRIEF DESCRIPTION OF THE DRAWINGS

FIGS. 1A, 1B, and 1C are schematic construction diagrams showing an image projection device according to a first embodiment of the present invention;

FIGS. 2A, 2B, and 2C are schematic construction diagrams showing an image projection device according to a second embodiment of the invention;

FIG. 3 is an optical path diagram illustrating a difference in an angle of refraction arising from a difference in a beam width with respect to a rod integrator; and

FIG. 4 is an optical path diagram illustrating a difference in an angle of refraction arising from differences in an optical path length up to the rod integrator and a beam width.

### DETAILED DESCRIPTION OF PREFERRED EMBODIMENTS

Hereinafter, the embodiments, etc. of an illumination optical system according to the present invention and an image projection device using such an illumination optical system will be described with reference to the accompanying drawings. Note that those portions which are identical or equivalent to each other among the different embodiments, etc. are provided with the same numerals and thus their overlapping description will be omitted as appropriate. Moreover, in each of the embodiments, as a light source that emits illumination light having a flat beam cross section, a laser array light source is exemplified, although the light source is not limited thereto.

### First Embodiment

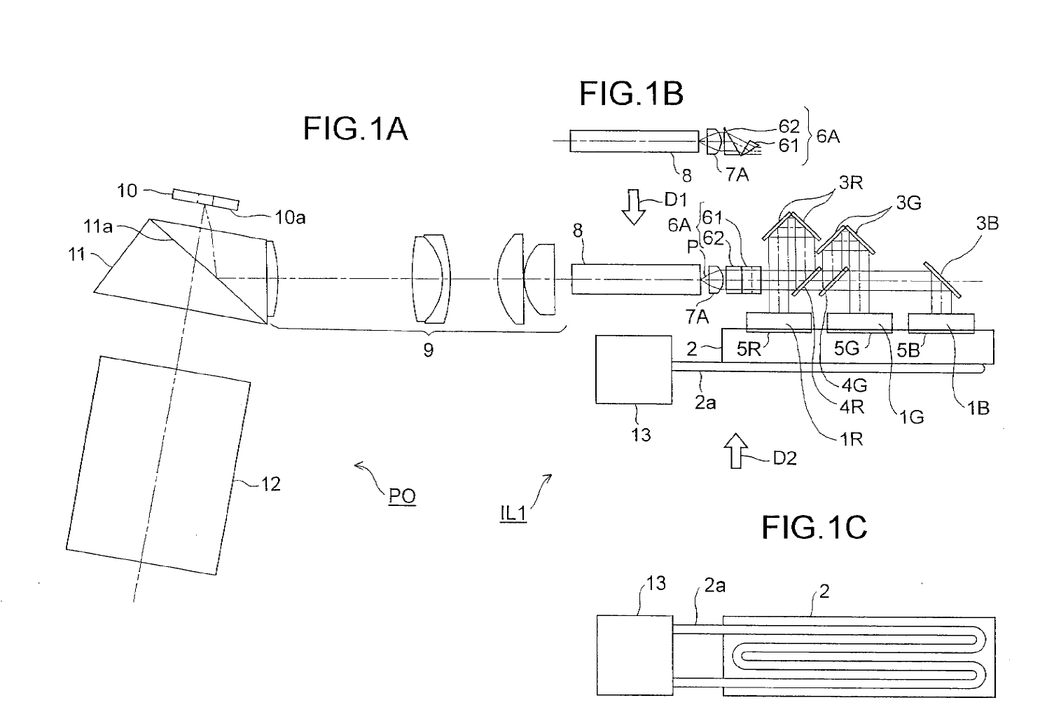

FIG. 1A shows main optical arrangement of the image projection device including an illumination optical system IL1 according to the first embodiment, as viewed from the top. This image projection device includes: a display element 10; the illumination optical system IL1 for illuminating an image display surface 10a of the display element 10; and a projection optical system PO for projecting an image displayed on the image display surface 10a onto a screen (not shown) on an enlarged scale. The illumination optical system IL1 is composed of: laser array light sources 1R, 1G, and 1B; reflecting mirrors 3R, 3G, and 3B; dichroic mirrors 4R and 4G; a beam expander 6A composed of a first prism 61 and a second prism 62; a convex lens 7A; a rod integrator 8; a relay optical system 9; etc. Optical configuration after the rod integrator 8, that is, the relay optical system 9, the display element 10, a total internal reflection (TIR) prism 11; and a projection lens 12 have the same structure as those of a typical image projection device using a discharge lamp.

The laser array light source 1R emits illumination light of a red color (R), the laser array light source 1G emits illumination light of a green color (G), and the laser array light source 1B emits illumination light of a blue color (B). That is, the three laser array light sources 1R, 1G, and 1B emitting illumination light of the three primary colors R, G, and B, respectively, flash sequentially, and the display element 10 displays on the image display surface 10a images in accordance with the respective colors of the illumination light, whereby a color image is displayed.

Each of the laser array light sources 1R, 1G, and 1B has flat light source arrangement (for example, 1 or 2 rows by 10 sequences). Thus, the illumination light emitted from each of the laser array light sources 1R, 1G, and 1B has a flat beam cross section. Then, the three laser array light sources 1R, 1G, and 1B are arranged so that long directions of the cross sections of the illumination light form a substantially straight line, and to the three laser array light sources 1R, 1G, and 1B, a heat sink 2 to be shared is fitted. FIG. 1C shows a cooling pump 13, a liquid cooling pipe 2a, and the heat sink 2 as viewed from a direction of arrow D2 in FIG. 1A (that is, from a side opposite to the side on which the laser array light sources 1R, 1G, and 1B are provided).

As shown in FIGS. 1A and 1C, the cooling pump 13 is arranged on the side surface side of the heat sink 2. A coolant is fed from the cooling pump 13 to the liquid cooling pipe 2a to take heat away from the heat sink 2, thereby cooling the laser array light sources 1R, 1G, and 1B. As can be seen from FIG. 1C, the liquid cooling pipe 2a is arranged so that the coolant is fed along the direction in which the three laser array light sources 1R, 1G, and 1B are arranged. This cooling structure can be adopted by arranging the laser array light sources 1R, 1G, and 1B in a straight line. That is, through the straight layout of the laser array light sources 1R, 1G, and 1B, the shared cooling mechanism can be used, which requires only one place for cooling, thereby permitting very efficient cooling. Especially when a light source such as a semiconductor laser, a light emitting diode (LED), or the like is handled, its cooling also affect the amount of emission, and thus the aforementioned layout in the illumination optical system is very important.

Moreover, as shown in FIG. 1A, terminals 5R, 5G, and 5B for driving the laser array light sources 1R, 1G, and 1B, respectively are arranged on the same plane and in the same direction so as to be easily connected to a control board (not shown). When a light source such as a semiconductor laser, an LED, or the like is handled, a large current is fed; thus, also from viewpoints of efficiency, safety, etc., it is important to arrange the laser array light sources 1R, 1G, and 1B in the layout described above.

The illumination light of R emitted from the laser array light source 1R is reflected by the two reflecting mirrors 3R and then reflected by the dichroic mirror 4R. The dichroic mirror 4R reflects the illumination light of R and transmits the illumination light of G and B; therefore, the illumination light of R is reflected by the dichroic mirror 4R, so that its optical path is merged to travel along the same optical axis as that of the illumination light of G and B. The illumination light of R after the merging enters the beam expander 6A.

The illumination light of G emitted from the laser array light source 1G is reflected by the two reflecting mirrors 3G and then reflected by the dichroic mirror 4G. The dichroic mirror 4G reflects the illumination light of G and transmits the illumination light of B; therefore, the illumination light of G is reflected by the dichroic mirror 4G, so that its optical path is merged to travel along the same optical axis as that of the illumination light of B. The illumination light of G after the merging is transmitted through the dichroic mirror 4R and enters the beam expander 6A.

The illumination light of B emitted from the laser array light source 1B is reflected by the reflecting mirror 3B and then sequentially transmitted through the dichroic mirrors 4G and 4R, so that its optical path is merged to travel along the same optical axis as that of the illumination light of R and G. The illumination light of B after the merging enters the beam expander 6A.

As described above, the illumination lights of R, G, and B are merged into an identical optical path by the five reflecting mirrors 3R, 3G, and 3B and the two dichroic mirrors 4R and 4G. Through this optical path merging (that is, color synthesis), the illumination light of R, G, and B become coaxial with each other and also have the same optical path length from an emission surface to the rod integrator 8. As a result, their beam cross sections on the same plane after the merging become substantially equal to each other, details of which will be described later on.

The illuminations light of R, G, and B after the merging is each beam-shaped by the beam expander 6A composed of the first prism 61 and the second prism 62, condensed by the convex lens 7A, and then enters the rod integrator 8. As described above, the illumination light emitted from each of the laser array light sources 1R, 1G, and 1B has a flat beam cross section. For this illumination light, in FIG. 1A showing the main optical arrangement as viewed from the top, the beam expander 6A, the convex lens 7A, and the rod integrator 8 are shown as viewed from the side on which their beam widths are larger. In FIG. 1B, the beam expander 6A, the convex lens 7A, and the rod integrator 8 are shown as viewed from a direction of arrow D1 in FIG. 1A (i.e., a side on which their beam widths are smaller).

The first prism 61 and the second prism 62 are arranged so as to enlarge a beam width of illumination light in a short direction of its beam cross section to thereby reduce flatness of the beam cross section (i.e., bring flattening closer to zero). Although a function as a beam expander can be achieved even with only one prism, the use of two prisms permits a travel direction of an illumination beam P to be equal between the incidence side and the exit side, thereby increasing the degree of a change in flattening. Moreover, configuration such that beam shaping is performed before illumination light enters the rod integrator 8 has the advantage of an improved degree of freedom in layout.

Illumination beam P, after its smaller beam width is enlarged to the same size as that of the larger beam width by the beam expander 6A, is condensed by the convex lens 7A in such a manner as to be focused near the incidence end surface of the rod integrator 8. The use of the convex lens 7A facilitates positioning, assembly, etc. of the beam expander 6A and the convex lens 7A. Instead of the convex lens 7A, however, a concave lens may be used, and the first prism 61 and the second prism 62 may be so arranged as to narrow down a larger beam width. Configuration such that a beam width of illumination light in a long direction of its beam cross section is reduced permits use of more compact components, which also permits compact layout.

The illumination light of R, G, and B condensed by the convex lens 7A each passes through the rod integrator 8 whereby its intensity is uniformized. The rod integrator 8 assumed here is hollow-rod type light intensity uniformizing means composed of four flat mirrors attached together. Illumination light entering from the incidence end surface is repeatedly reflected by the side surface (that is, inner wall surface) of the rod integrator 8 and thereby mixed, and then exits from the exit end surface after spatial energy distribution of the illumination light is uniformized. The shapes of the incidence end surface and exit end surface of the rod integrator 8 are rectangular, i.e., substantially similar to that of the image display surface 10a of the display element 10, and the exit end surface of the rod integrator 8 conjugates with the image display surface 10a of the display element 10. Therefore, through the uniformization of brightness distribution on the exit end surface due to the mixing effect described above, the display element 10 is illuminated efficiently and uniformly.

The rod integrator 8 is not limited to a hollow rod but may be a glass rod formed of a glass body in the shape of a quadrangular prism. Moreover, the number of its side surfaces is not limited to four as long as its shape fits the shape of the image display surface 10a of the display element 10. That is, the shape of its cross section is not limited to a quadrilateral such as a rectangle. Therefore, examples of the rod integrator 8 used include: a hollow cylindrical body composed of a plurality of reflecting mirrors combined together; a glass body formed in the shape of a polygonal column; etc.

In this illumination optical system IL1, as can be seen from FIGS. 1A and 1B, the illumination beam P is angled by the convex lens 7A, thereby making it easier to reflect the illumination beam P inside the rod integrator 8. In this manner, providing the configuration such that illumination light from the laser array light sources 1R, 1G, and 1B is condensed by the convex lens 7A (or diverged by a concave lens) causes the illumination light to enter the rod integrator 8 at a larger angle with respect thereto (that is, at a large angle of incidence with respect to the incidence end surface), thus increasing the number of times of reflection inside the rod integrator 8, which makes it easier to provide uniform luminance distribution.

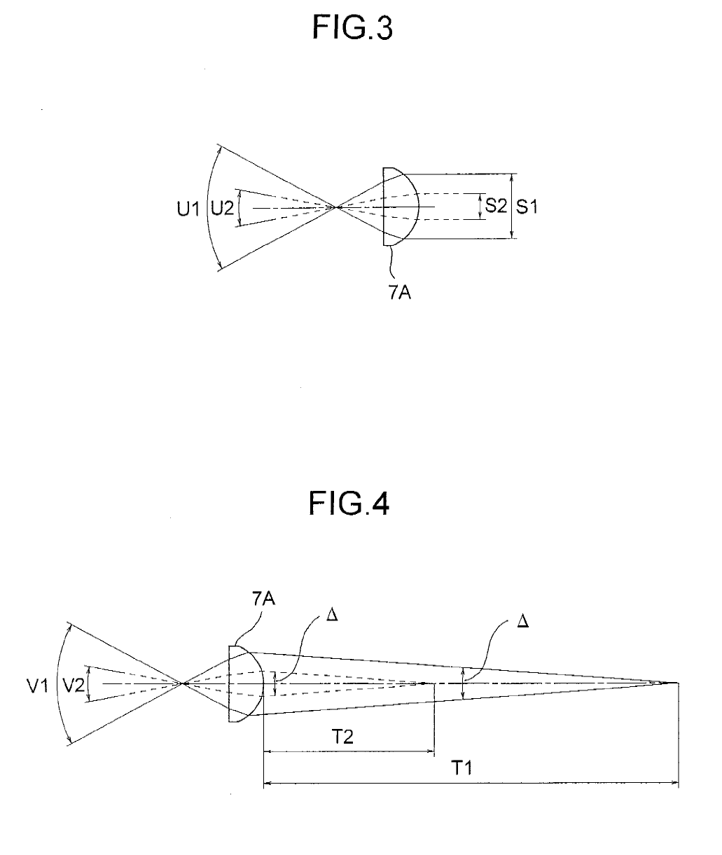

When illumination light having a flat-shaped beam cross section is condensed by the convex lens 7A without subjected to beam shaping, as shown in FIG. 3, a difference arises between beam angles of refraction U1 and U2 due to a difference between beam widths S1 and S2. That is, as compared to the larger beam width S1, the smaller beam width S2 does not provide a large angle with respect to the rod integrator 8. Thus, inside the rod integrator 8, the number of times of reflection in this direction decreases, thus making it difficult to provide uniform luminance distribution and isotropic NA distribution.

To solve the problem described above, in this illumination optical system IL1, provided as an optical member for reducing the flatness of a beam cross section is the beam expander 6A for enlarging a beam width of illumination light in a short direction of its beam cross section. Since improvement is achieved so that the flatness of the beam cross section of the illumination light is reduced by the beam expander 6A (that is, so that the flattening is brought closer to zero), flat NA distribution is converted into isotropic NA distribution. That is, through the isotropic correction of the beam width with the beam expander 6A, illumination light traveling via the convex lens 7A come to have isotropic NA distribution. Since an illumination beam P having isotropic NA distribution can be provided while the laser array light sources 1R, 1G, and 1B and also compact configuration are provided, uniform luminance distribution can be provided while holding high illumination efficiency and high resolution of the projected image. Since illumination light is condensed by the convex lens 7A, the illumination light enters the rod integrator 8 at a larger angle with respect thereto. As a result, the number of times of reflection inside the rod integrator 8 increases, thus making it easier to provide uniform luminance distribution. Therefore, a combination of the beam expander 6A, the convex lens 7A, and the rod integrator 8 uniformizes the NA distribution and brightness distribution on the exit end surface of the rod integrator 8, so that homogeneous illumination can be achieved with the illumination beam P having isotropic NA distribution.

Providing this illumination optical system IL1 in an image projection device (rear projector, front projection, or the like) can resolve a problem attributable to flat NA distribution specific to a laser array light source, which greatly contributes to compactification, cost reduction, brightness enhancement, performance enhancement, function enhancement, etc. A device to which this illumination optical system IL1 is applied is not limited to an image projection device. The illumination optical system IL1 can be applied to any device as long as the device requires illumination light having isotropic NA distribution.

For beams emitted from a directional light source, such as a laser light source, close to a point light source at the same micro angle of divergence A as shown in FIG. 4, a difference between optical path lengths T1 and T2 thereof directly results in a difference between beam widths on an optical component (the convex lens 7A here). Thus, the difference between the optical path lengths T1 and T2 from the laser array light sources 1R, 1G, and 1B for R, G, and B results in a relatively larger difference, i.e., ratio between the beam widths on the convex lens 7A, thereby causing a large difference between angles of divergence V1 and V2 of the different colors on the convex lens 7A. Thus, an NA difference arises between the different colors, thus causing color unevenness. In the illumination optical system IL1 shown in FIGS. 1A, 1B, and 1C, optical arrangement is achieved so that the three beams of R, G, and B whose optical paths have been merged enter the rod integrator 8 in the same degree of divergence, which eliminates the risk of occurrence of color unevenness as described above. Then, the prevention of the occurrence of color unevenness permits more reliably achieving illumination with uniform luminance distribution that is substantially equal among the light of the different colors. Moreover, adopting optical arrangement such that optical path lengths from the laser array light sources 1R, 1G, and 1B to the rod integrator 8 are equal permits the prevention of the occurrence of color unevenness with more simple configuration.

As shown in FIG. 1A, illumination light exiting from the rod integrator 8 enters the TIR prism 11 through the relay optical system 9. The illumination light entering the TIR prism 11 is totally reflected by an air gap surface 11a of the TIR prism 11 and then uniformly irradiates the image display surface 10a of the display element 10. At this point, the relay optical system 9 relays the illumination light from the exit end surface of the rod integrator 8 to the image display surface 10a of the display element 10, focusing it thereon. That is, on the image display surface 10a of the display element 10, an image on the exit end surface of the rod integrator 8 is formed. If the display element is transmissive, without using the relay optical system 9, the display element may be arranged near the exit end surface of the rod integrator 8.

On the image display surface 10a of the display element 10, a two-dimensional image is formed by intensity modulation of the illumination light. Here, a digital micromirror device is assumed as the display element 10. However, the display element 10 used is not limited thereto, and thus another non-luminous, reflective (or transmissive) display element (for example, liquid crystal display element) suitable for the projection optical system PO may be used. When the digital micromirror device is used as the display element 10, light entering it is reflected by each micro mirror in an ON/OFF state (for example, at an inclination of ±12°) and thereby spatially modulated. At this point, only the light reflected by a micromirror in an ON state is transmitted through the air gap surface 11a of the TIR prism 11 without being totally reflected, enters the projection lens 12, and then is projected onto the screen. On the other hand, the light reflected by a micromirror in an OFF state is greatly deflected toward the side opposite to the side to which the illumination light travels in the TIR prism 11, and thus does not enter the projection lens 12. In this manner, by a power of the projection lens 12 forming the projection optical system PO, a display image on the image display surface 10a is projected onto the screen on an enlarged scale.

### Second Embodiment

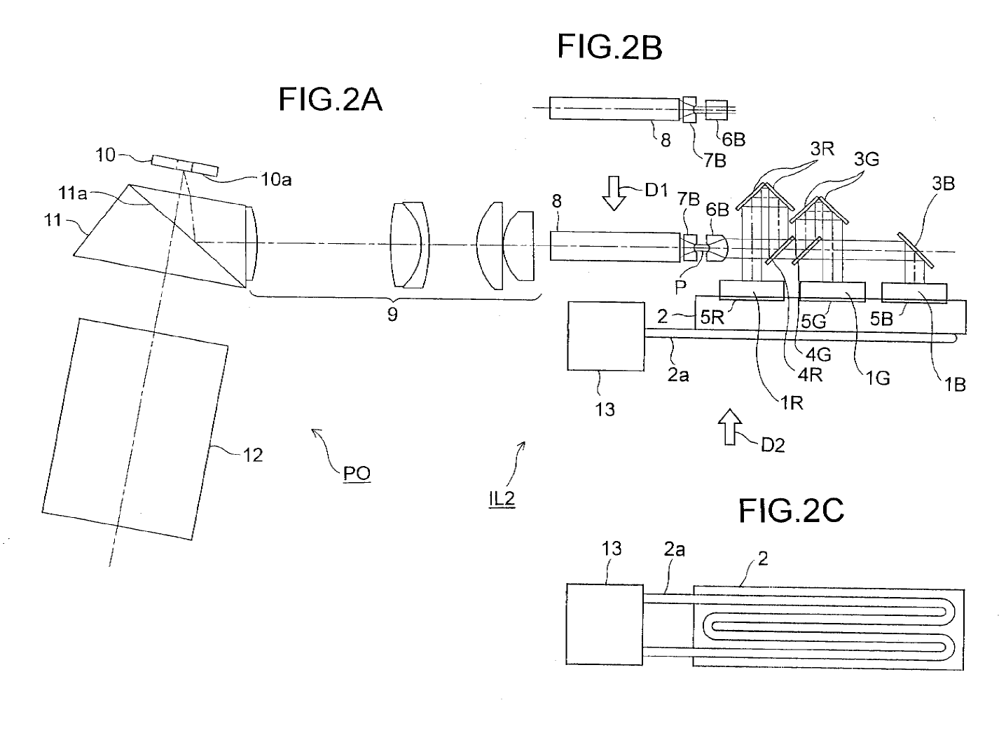

FIG. 2A shows main optical arrangement of the image projection device including an illumination optical system IL2 according to the second embodiment, as viewed from the top. This image projection device includes: a display element 10; the illumination optical system IL2 for illuminating an image display surface 10a of the display element 10; and a projection optical system PO for projecting an image displayed on the image display surface 10a onto a screen (not shown) on an enlarged scale. The illumination optical system IL2 is composed of: laser array light sources 1R, 1G, and 1B; reflecting mirrors 3R, 3G, and 3B; dichroic mirrors 4R and 4G; a cylindrical lens 6B; a concave lens 7B; a rod integrator 8; a relay optical system 9; etc. Optical configuration after the rod integrator 8, that is, the relay optical system 9, the display element 10, a total internal reflection (TIR) prism 11; and a projection lens 12 have the same structure as those of a typical image projection device using a discharge lamp.

The laser array light source 1R emits illumination light of a red color (R), the laser array light source 1G emits illumination light of a green color (G), and the laser array light source 1B emits illumination light of a blue color (B). That is, the three laser array light sources 1R, 1G, and 1B emitting illumination light of the three primary colors R, G, and B, respectively, flash sequentially, and the display element 10 displays on the image display surface 10a images in accordance with the respective colors of the illumination light, whereby a color image is displayed.

Each of the laser array light sources 1R, 1G, and 1B has flat light source arrangement (for example, 1 or 2 rows by 10 sequences). Thus, the illumination light emitted from each of the laser array light sources 1R, 1G, and 1B has a flat beam cross section. Then, the three laser array light sources 1R, 1G, and 1B are arranged so that long directions of the cross sections of the illumination light form a substantially straight line, and to the three laser array light sources 1R, 1G, and 1B, a heat sink 2 to be shared is fitted. FIG. 2C shows a cooling pump 13, a liquid cooling pipe 2a, and the heat sink 2 as viewed from a direction of arrow D2 in FIG. 2A (that is, from a side opposite to the side on which the laser array light sources 1R, 1G, and 1B are provided).

As shown in FIGS. 2A and 2C, the cooling pump 13 is arranged on the side surface side of the heat sink 2. A coolant is fed from the cooling pump 13 to the liquid cooling pipe 2a to take heat away from the heat sink 2, thereby cooling the laser array light sources 1R, 1G, and 1B. As can be seen from FIG. 2C, the liquid cooling pipe 2a is arranged so that the coolant is fed along the direction in which the three laser array light sources 1R, 1G, and 1B are arranged. This cooling structure can be adopted by arranging the laser array light sources 1R, 1G, and 1B in a straight line. That is, through the straight layout of the laser array light sources 1R, 1G, and 1B, the shared cooling mechanism can be used, which requires only one place for cooling, thereby permitting very efficient cooling. Especially when a light source such as a semiconductor laser, a light emitting diode (LED), or the like is handled, its cooling also affect the amount of emission, and thus the aforementioned layout in the illumination optical system is very important.

Moreover, as shown in FIG. 2A, terminals 5R, 5G, and 5B for driving the laser array light sources 1R, 1G, and 1B, respectively are arranged on the same plane and in the same direction so as to be easily connected to a control board (not shown). When a light source such as a semiconductor laser, an LED, or the like is handled, a large current is fed; thus, also from viewpoints of efficiency, safety, etc., it is important to arrange the laser array light sources 1R, 1G, and 1B in the layout described above.

The illumination light of R emitted from the laser array light source 1R is reflected by the two reflecting mirrors 3R and then reflected by the dichroic mirror 4R. The dichroic mirror 4R reflects the illumination light of R and transmits the illumination light of G and B; therefore, the illumination light of R is reflected by the dichroic mirror 4R, so that its optical path is merged to travel along the same optical axis as that of the illumination light of G and B. The illumination light of R after the merging enters the cylindrical lens 6B.

The illumination light of G emitted from the laser array light source 1G is reflected by the two reflecting mirrors 3G and then reflected by the dichroic mirror 4G. The dichroic mirror 4G reflects the illumination light of G and transmits the illumination light of B; therefore, the illumination light of G is reflected by the dichroic mirror 4G, so that its optical path is merged to travel along the same optical axis as that of the illumination light of B. The illumination light of G after the merging is transmitted through the dichroic mirror 4R and enters the cylindrical lens 6B.

The illumination light of B emitted from the laser array light source 1B is reflected by the reflecting mirror 3B and then sequentially transmitted through the dichroic mirrors 4G and 4R, so that its optical path is merged to travel along the same optical axis as that of the illumination light of R and G. The illumination light of B after the merging enters the cylindrical lens 6B.

As described above, the illumination lights of R, G, and B are merged into an identical optical path by the five reflecting mirrors 3R, 3G, and 3B and the two dichroic mirrors 4R and 4G. Through this optical path merging (that is, color synthesis), the illumination light of R, G, and B become coaxial with each other and also have the same optical path length from an emission surface to the rod integrator 8. As a result, their beam cross sections on the same plane after the merging become substantially equal to each other, details of which will be described later on.

The illuminations light of R, G, and B after the merging is each beam-shaped by the cylindrical lens 6B, diverged by the concave lens 7B, and then enters the rod integrator 8. As described above, the illumination light emitted from each of the laser array light sources 1R, 1G, and 1B has a flat beam cross section. For this illumination light, in FIG. 2A showing the main optical arrangement as viewed from the top, the cylindrical lens 6B, the concave lens 7B, and the rod integrator 8 are shown as viewed from the side on which their beam widths are larger. In FIG. 2B, the cylindrical lens 6B, the concave lens 7B, and the rod integrator 8 are shown as viewed from a direction of arrow D1 in FIG. 2A (i.e., a side on which their beam widths are smaller).

The cylindrical lens 6B is an afocal system so arranged as to reduce a beam width of illumination light in a long direction of its beam cross section to thereby reduce flatness of the beam cross section (i.e., bring flattening closer to zero). By reducing a beam width of such illumination light in a long direction of its beam cross section, compact components can be used as the cylindrical lens 6B and the concave lens 7B. Moreover, configuration such that beam shaping is performed before illumination light enters the rod integrator 8 has the advantage of an improved degree of freedom in layout.

Illumination beam P, after its larger beam width is reduced to the same size as that of the smaller beam width by the cylindrical lens 6B, is diverged by the concave lens 7B. The use of the concave lens 7B permits compact layout of the cylindrical lens 6B and the concave lens 7B. Instead of the concave lens 7B, however, a convex lens may be used, and instead of the cylindrical lens 6B, a cylindrical lens such as enlarges a smaller beam width may be used, although the configuration of this embodiment permits use of more compact components and more compact layout. From viewpoints of compactification, for example, configuration such that the cylindrical lens 6B and the concave lens 7B are replaced with an integral component having a convex cylindrical surface on the laser array light sources 1R, 1G, and 1B side and a concave troidal surface on the rod integrator 8 side may be provided.

The illumination light of R, G, and B diverged by the concave lens 7B each passes through the rod integrator 8 whereby its intensity is uniformized. The rod integrator 8 assumed here is hollow-rod type light intensity uniformizing means composed of four flat mirrors attached together. Illumination light entering from the incidence end surface is repeatedly reflected by the side surface (that is, inner wall surface) of the rod integrator 8 and thereby mixed, and then exits from the exit end surface after spatial energy distribution of the illumination light is uniformized. The shapes of the incidence end surface and exit end surface of the rod integrator 8 are rectangular, i.e., substantially similar to that of the image display surface 10a of the display element 10, and the exit end surface of the rod integrator 8 conjugates with the image display surface 10a of the display element 10. Therefore, through the uniformization of brightness distribution on the exit end surface due to the mixing effect described above, the display element 10 is illuminated efficiently and uniformly.

The rod integrator 8 is not limited to a hollow rod but may be a glass rod formed of a glass body in the shape of a quadrangular prism. Moreover, the number of its side surfaces is not limited to four as long as its shape fits the shape of the image display surface 10a of the display element 10. That is, the shape of its cross section is not limited to a quadrilateral such as a rectangle. Therefore, examples of the rod integrator 8 used include: a hollow cylindrical body composed of a plurality of reflecting mirrors combined together; a glass body formed in the shape of a polygonal column; etc.

In this illumination optical system IL2, as can be seen from FIGS. 2A and 2B, the illumination beam P is angled by the concave lens 7B, thereby making it easier to reflect the illumination beam P inside the rod integrator 8. In this manner, providing the configuration such that illumination light from the laser array light sources 1R, 1G, and 1B is diverged by the concave lens 7B (or condensed by a convex lens) causes the illumination light to enter the rod integrator 8 at a larger angle with respect thereto (that is, at a large angle of incidence with respect to the incidence end surface), thus increasing the number of times of reflection inside the rod integrator 8, which makes it easier to provide uniform luminance distribution.

When illumination light having a flat-shaped beam cross section is diverged by the concave lens 7B without subjected to beam shaping, a difference arises in a beam angle of refraction due to a difference in a beam width. That is, as compared to the larger beam width, the smaller beam width does not provide a large angle with respect to the rod integrator 8. Thus, inside the rod integrator 8, the number of times of reflection in this direction decreases, thus making it difficult to provide uniform luminance distribution and isotropic NA distribution.

To solve the problem described above, in this illumination optical system IL2, provided as an optical member for reducing the flatness of a beam cross section is the cylindrical lens 6B for reducing a beam width of illumination light in a long direction of its beam cross section. Since improvement is achieved so that the flatness of the beam cross section of the illumination light is reduced by the cylindrical lens 6B (that is, so that the flattening is brought closer to zero), flat NA distribution is converted into isotropic NA distribution. That is, through the isotropic correction of the beam width with the cylindrical lens 6B, illumination light traveling via the concave lens 7B come to have isotropic NA distribution. Since an illumination beam P having isotropic NA distribution can be provided while the laser array light sources 1R, 1G, and 1B and also compact configuration are provided, uniform luminance distribution can be provided while holding high illumination efficiency and high resolution of the projected image. Since illumination light is diverged by the concave lens 7B, the illumination light enters the rod integrator 8 at a larger angle with respect thereto. As a result, the number of times of reflection inside the rod integrator 8 increases, thus making it easier to provide uniform luminance distribution. Therefore, a combination of the cylindrical lens 6B, the concave lens 7B, and the rod integrator 8 uniformizes the NA distribution and brightness distribution on the exit end surface of the rod integrator 8, so that homogeneous illumination can be achieved with the illumination beam P having isotropic NA distribution.

Providing this illumination optical system IL2 in an image projection device (rear projector, front projection, or the like) can resolve a problem attributable to flat NA distribution specific to a laser array light source, which greatly contributes to compactification, cost reduction, brightness enhancement, performance enhancement, function enhancement, etc. A device to which this illumination optical system IL2 is applied is not limited to an image projection device. The illumination optical system IL2 can be applied to any device as long as the device requires illumination light having isotropic NA distribution. If the display element is transmissive, without using the relay optical system 9, the display element may be arranged near the exit end surface of the rod integrator 8.

For beams emitted from a directional light source, such as a laser light source, close to a point light source at the same micro angle of divergence, a difference between optical path lengths directly results in a difference between beam widths on an optical component (cylindrical lens 6B and concave lens 7B here). Thus, the difference between the optical path lengths from the laser array light sources 1R, 1G, and 1B for R, G, and B results in a relatively larger difference, i.e., ratio between the beam widths on the cylindrical lens 6B and the concave lens 7B, thereby causing a large difference between angles of divergence of the different colors on the cylindrical lens 6B and the concave lens 7B. Thus, an NA difference arises among the different colors, thus causing color unevenness. In the illumination optical system IL2 shown in FIGS. 2A, 2B, and 2C, optical arrangement is achieved so that the three beams of R, G, and B whose optical paths have been merged enter the rod integrator 8 in the same degree of divergence, which eliminates the risk of occurrence of color unevenness as described above. Then, the prevention of the occurrence of color unevenness permits more reliably achieving illumination with uniform luminance distribution that is substantially equal among the light of the different colors. Moreover, adopting optical arrangement such that optical path lengths from the laser array light sources 1R, 1G, and 1B to the rod integrator 8 are equal permits the prevention of the occurrence of color unevenness with more simple configuration.

As shown in FIG. 2A, illumination light exiting from the rod integrator 8 enters the TIR prism 11 through the relay optical system 9. The illumination light entering the TIR prism 11 is totally reflected by an air gap surface 11a of the TIR prism 11 and then uniformly irradiates the image display surface 10a of the display element 10. At this point, the relay optical system 9 relays the illumination light from the exit end surface of the rod integrator 8 to the image display surface 10a of the display element 10, focusing it thereon. That is, on the image display surface 10a of the display element 10, an image on the exit end surface of the rod integrator 8 is formed.

On the image display surface 10a of the display element 10, a two-dimensional image is formed by intensity modulation of the illumination light. Here, a digital micromirror device is assumed as the display element 10. However, the display element 10 used is not limited thereto, and thus another non-luminous, reflective (or transmissive) display element (for example, liquid crystal display element) suitable for the projection optical system PO may be used. When the digital micromirror device is used as the display element 10, light entering it is reflected by each micro mirror in an ON/OFF state (for example, at an inclination of ±12°) and thereby spatially modulated. At this point, only the light reflected by a micromirror in an ON state is transmitted through the air gap surface 11a of the TIR prism 11 without being totally reflected, enters the projection lens 12, and then is projected onto the screen. On the other hand, the light reflected by a micromirror in an OFF state is greatly deflected toward the side opposite to the side to which the illumination light travels in the TIR prism 11, and thus does not enter the projection lens 12. In this manner, by a power of the projection lens 12 forming the projection optical system PO, a display image on the image display surface 10a is projected onto the screen on an enlarged scale.

As can be understood from the above, the embodiments described above include the following configuration (A1) to (A7) of an illumination optical system and an image projection device.

(A1) An illumination optical system for illuminating an image display surface of a display element includes: a light source emitting illumination light having a flat beam cross section; a first optical member reducing flatness of the beam cross section; a second optical member condensing or diverging the illumination light; and a rod integrator uniformizing spatial energy distribution of the illumination light subjected to optical action of the first and second optical members.

(A2) The illumination optical system described in the above (A1), wherein the light source is a laser array light source.

(A3) The illumination optical system described in the above (A1) or (A2), wherein the second optical member is a convex lens, the first optical member enlarges a beam width of the illumination light in a short direction of a beam cross section thereof, and the convex lens makes the already enlarged illumination light enter the rod integrator.

(A4) The illumination optical system described in the above (A1) or (A2), wherein the second optical member is a concave lens, the first optical member reduces a beam width of the illumination light in a long direction of a beam cross section thereof, and the concave lens makes the already reduced illumination light enter the rod integrator.

(A5) The illumination optical system described in any one of the above (A1) to (A4), wherein as the light source, three light sources are provided which emit illumination light of three primary colors R, G, and B, respectively, the illumination optical system further has an optical path merging member which merges the illumination light emitted from the light sources into one optical path, and three beams of the light whose optical paths have been merged by the optical path merging member are optically arranged so as to enter the rod integrator in a same degree of divergence or condensation.

(A6) The illumination optical system described in the above (A5), wherein the optical paths from the light sources to the rod integrator have a same length.

(A7) An image projection device including the illumination optical system described in any one of the above (A1) to (A6).

According to the illumination optical system described in the above (A1), since improvement is achieved so that the flatness of the beam cross section of the illumination light is reduced by the first optical member (that is, so that the flattening is brought closer to zero), flat NA distribution is converted into isotropic NA distribution. Since an illumination beam having isotropic NA distribution can be provided while the light sources emitting a beam having a flat cross section and also compact configuration are provided, uniform luminance distribution can be provided while holding high illumination efficiency and high resolution of the projected image. Moreover, since the illumination light is condensed or diverged by the second optical member, the illumination light enters the rod integrator at a larger angle with respect thereto. As a result, the number of times of reflection inside the rod integrator increases, thus making it easier to provide uniform luminance distribution. Therefore, a combination of the first and second optical members and the rod integrator permits achieving homogeneous illumination with the illumination beam having isotropic NA distribution.

Using the aforementioned characteristic illumination optical system in an image projection device (rear projector, front projection, or the like) as described in the above (A7) can resolve, for example, a problem attributable to flat NA distribution specific to a laser array light source, which greatly contributes to compactification, cost reduction, brightness enhancement, performance enhancement, function enhancement, etc. A device to which the illumination optical system described in the above (A1) is applied is not limited to an image projection device. The illumination optical system can be applied to any device as long as the device requires illumination light having isotropic NA distribution.

According to the illumination optical system described in the above (A3), since the first optical member enlarges the beam width of the illumination light in the short direction of the beam cross section thereof, for example, a beam expander composed of two prisms combined together with simple configuration can be used as the first optical member. Further, since the convex lens is used as the second optical member, positioning, assembly, etc. of the first and second optical members can be easily performed.

According to the illumination optical system described in the above (A4), since the first optical member reduces the beam width of the illumination light in the long direction of the beam cross section thereof, more compact components can be used as the first and second optical members. Further, since a concave lens is used as the second optical member, layout of the first and second optical members can be made compact.

According to the illumination optical system described in the above (A5), since the three light sources are provided which emit illumination light of three primary colors R, G, and B, respectively, and the optical path merging member merges the illumination light emitted from the light sources into one optical path, illumination for a full color is possible. Further, since the three beams of the light whose optical paths have been merged by the optical path merging member are optically arranged so as to enter the rod integrator in a same degree of divergence or condensation, occurrence of color unevenness can be prevented. Therefore, illumination with uniform luminance distribution that is substantially equal among the light of the different colors can be more reliably achieved.

Further, as in the illumination optical system described in the above (A6), adopting optical arrangement such that optical paths from the laser array light sources to the rod integrator have a same length permits prevention of the occurrence of color unevenness with simple configuration. For example, by use of a light source device, such as a laser light source, close to a point light source that emits light at the same micro angle of divergence, a difference between the optical path lengths directly results in a difference between beam widths on an optical component. Thus, with the difference between the optical path lengths from the laser array light sources for R, G, and B to the rod integrator, the difference between the beam widths becomes a difference between angles of divergence, thus causing color unevenness due to an NA difference between the colors. Adopting the optical arrangement such that the optical paths from the laser array light sources for R, G, and B to the rod integrator have a same length can eliminates the risk of occurrence of such color unevenness.

What is claimed is:

1. An illumination optical system for illuminating an image display surface of a display element, the illumination optical system comprising:
a light source emitting illumination light having a flat beam cross section;
a first optical member reducing flatness of the beam cross section;
a second optical member condensing or diverging the illumination light from the first optical member; and
a rod integrator uniformizing spatial energy distribution of the illumination light subjected to optical action of the first and second optical members.

2. The illumination optical system according to claim 1,
wherein the light source is a laser array light source.

3. The illumination optical system according to claim 1,
wherein the second optical member is a convex lens,
wherein the first optical member enlarges a beam width of the illumination light in a short direction of a beam cross section thereof, and
wherein the convex lens makes the already enlarged illumination light enter the rod integrator.

4. The illumination optical system according to claim 1,
wherein the second optical member is a concave lens,
wherein the first optical member reduces a beam width of the illumination light in a long direction of a beam cross section thereof, and
wherein the concave lens makes the already reduced illumination light enter the rod integrator.

5. The illumination optical system according to claim 1,
wherein as the light source, three light sources are provided which emit illumination light of three primary colors R, G, and B, respectively,
wherein the illumination optical system further has an optical path merging member which merges the illumination light emitted from the light sources into one optical path, and
wherein three beams of the light whose optical paths have been merged by the optical path merging member are optically arranged so as to enter the rod integrator in a same degree of divergence or condensation.

6. The illumination optical system according to claim 5,
wherein the optical paths from the light sources to the rod integrator have a same length.

7. The illumination optical system according to claim 2,
wherein the laser array light source has: a laser array light source emitting red light, a laser array light source emitting green light, and a laser array light source emitting blue light, and
wherein the three laser array light sources are arranged so that cross sections, in long directions, of beams emitted from the respective laser array light sources form a substantially straight line.

8. The illumination optical system according to claim 1,
wherein the illumination optical system further has a relay optical system focusing an exit end surface of the rod integrator onto the image display surface.

9. An image projection device comprising:
an illumination optical system including:
a light source emitting illumination light having a flat beam cross section,
a first optical member reducing flatness of the beam cross section,
a second optical member condensing or diverging the illumination light from the first optical member, and
a rod integrator uniformizing spatial energy distribution of the illumination light subjected to optical action of the first and second optical members;
a display element forming an image by modulating the illumination light from the rod integrator; and
a projection optical system projecting on an enlarged scale the image formed by the display element.

10. The image projection device according to claim 9,
wherein the light source is a laser array light source.

11. The image projection device according to claim 9,
wherein the second optical member is a convex lens,
wherein the first optical member enlarges a beam width of the illumination light in a short direction of a beam cross section thereof, and
wherein the convex lens makes the already enlarged illumination light enter the rod integrator.

12. The image projection device according to claim 9,
wherein the second optical member is a concave lens,
wherein the first optical member reduces a beam width of the illumination light in a long direction of a beam cross section thereof, and
wherein the concave lens makes the already reduced illumination light enter the rod integrator.

13. The image projection device according to claim 9,
wherein as the light source, three light sources are provided which emit illumination light of three primary colors R, G, and B, respectively,
wherein the illumination optical system further has an optical path merging member which merges the illumination light emitted from the light sources into one optical path, and
wherein three beams of the light whose optical paths have been merged by the optical path merging member are optically arranged so as to enter the rod integrator in a same degree of divergence or condensation.

14. The image projection device according to claim 13,
wherein the optical paths from the light sources to the rod integrator have a same length.

15. The image projection device according to claim 10,
wherein the laser array light source has: a laser array light source emitting red light, a laser array light source emitting green light, and a laser array light source emitting blue light, and
wherein the three laser array light sources are arranged so that cross sections, in long directions, of beams emitted from the respective laser array light sources form a substantially straight line.

16. The image projection device according to claim 9,
wherein the illumination optical system further has a relay optical system focusing an exit end surface of the rod integrator onto the image display surface.
